(19) United States
(12) Patent Application Publication
(10) Pub. No.: US 2015/0090713 A1
(43) Pub. Date: Apr. 2, 2015

(54) FUEL FILLER DOOR MODULE

(71) Applicant: GM GLOBAL TECHNOLOGY OPERATIONS LLC, Detroit, MI (US)

(72) Inventors: Heiko Betzen, Bausendorf (DE); Anett Kilian, Trebur (DE)

(21) Appl. No.: 14/505,316

(22) Filed: Oct. 2, 2014

(30) Foreign Application Priority Data
Oct. 2, 2013 (DE) 102013016455.9

(51) Int. Cl. B60K 15/04

(52) U.S. Cl. CPC B60K 15/0406
USPC 220/86.2

(57) ABSTRACT

A fuel filler door module for installation in a motor vehicle is provided with a trough body that can be placed in a vehicle body along with a fuel filler door pivoted to the trough body. The trough body exhibits an axial through opening for accommodating a fuel filler neck, and a radially outwardly projecting fastening edge for attachment to the motor vehicle body. The fastening edge has a flexible sealing element arranged on it with a first sealing section that forms a sealing abutment against an interior side of the fuel filler door, extends in the radial direction and can be deformed in an axial direction.

### CROSS REFERENCE TO RELATED APPLICATION

This application claims priority to German Patent Application No. 102013016455.9 filed Oct. 2, 2013, which is incorporated herein by reference in its entirety.

### TECHNICAL FIELD

The present disclosure relates to a fuel filler door module for installation in a motor vehicle. The fuel filler door module here exhibits a trough body that can be placed in a vehicle body along with a fuel filler door pivoted to the trough body. The fuel filler door can be used to seal the trough body from the outside.

### BACKGROUND

Fuel filler door modules for installation in motor vehicles are sufficiently known. They exhibit a trough body that can be placed in a corresponding opening of a vehicle body, and typically exhibits an axial through hole for accommodating and guiding a fuel filler neck in the region of a floor section that comes to lie inside the body. The fuel filler door which is usually pivoted to a radially outer edge of the trough body can here be switched into a closed position and a release position by means of a suitable locking and unlocking mechanism.

In the closed position, the fuel filler door most often extends flush in the outer contour of a motor vehicle body, so that it seals the trough body and protects it against the penetration of dust and/or dirt. Push-push mechanisms are known for locking and unlocking a fuel filler door, which are distinguished by the fact that exerting an axially inwardly directed pressure on the fuel filler door unlocks the seal, after which the fuel filler door can be swiveled into an opened position. In order to unlock a push-push closing mechanism, however, the fuel filler door must first be pressed further inward by a prescribed amount proceeding from its flush, closed position, excessively pressed, as it were. DE 10 2009 039 810 A1 describes such a fuel filler door module designed for a push-push mechanism with a trough body, which exhibits a flange-like fastening edge protruding radially outward. A flexibly deformable, continuous axial sealing strap is further provided that extends along the fastening edge. In relation to a through opening of the trough body provided for a fuel filler neck, however, the latter extends axially outward, and comes to abut against an interior side of a fuel filler door pivoted to the trough body in a closed position.

The sealing strap extending in an axial direction must here be deformed or compressed in an axial direction to move the fuel filler door into an open position. At times, this requires a comparatively high exertion of force. In addition, the flexibility or elasticity of the axial sealing strap may diminish, for example induced by ageing, which under certain conditions can impair the function of the locking mechanism of the fuel filler door module during long-term operation.

### SUMMARY

An embodiment of the present disclosure provides a fuel filler door module that has been made more user and operator friendly, whose locking and unlocking mechanism can be actuated with a comparatively low exertion of force, and which enables a reliable and low-maintenance long-term operation.

A fuel filler door module is provided for installation in a motor vehicle. The fuel filler door module exhibits a trough body that can be placed in a motor vehicle body, more precisely in a motor vehicle body opening. A fuel filler door is here further pivoted to the trough body. In a closed position, the fuel filler door seals the trough body quasi completely, so that the fuel filler door comes to abut flush in the outer contour of the motor vehicle body. The trough body exhibits a fastening edge that protrudes radially outward for attachment to the motor vehicle body. The fastening edge can typically be used to attach the trough body to an opening margin of the body opening that is axially retracted in relation to the body outer contour.

The trough body further exhibits a floor section that in a final assembly position typically comes to lie on the motor vehicle body in the vehicle interior. The area of the floor section is provided with an axial through opening for accommodating a fuel filler neck. In a final assembly configuration, the fuel filler neck passes through the through opening, so that a fill opening of the fuel filler neck comes to lie inside the trough body that can be sealed by means of the fuel filler door.

A flexible sealing element is further situated on the fastening edge of the trough body. On an interior side of the fuel filler door, the latter exhibits a first sealing section that forms a sealing abutment, extends in a radial direction (r) and can be deformed in an axial direction (y). The axial direction (y) here extends in roughly the transverse direction of the vehicle (y) relative to a conventional arrangement in the lateral wall of a motor vehicle body. The through opening of the trough body is typically roughly circular in design, and here typically defines a plane perpendicular to the longitudinal extension of the fuel filler neck. The longitudinal extension of the fuel filler neck or the roughly cylindrical or cup-shaped configuration of the trough body here yields a type of cylindrical geometry that defines the radial and axial direction in the present context.

The axial direction and radial direction can equally refer to the geometry of the opening margin of the body opening. While the axial direction typically extends perpendicular to the respective body outer contour, the radial direction and a tangential direction perpendicular thereto typically coincides with the plane of the opening margin of the body opening, into which the trough body can be placed to form a seal.

Because the first sealing section of the sealing element extends in a radial direction, typically roughly parallel to the plane of the fuel filler door, and can further be deformed in an axial direction, the sealing element provided here can on the one hand provide a sealing function between the trough body and fuel filler door. On the other hand, the sealing element with its first sealing section that extends in a radial direction and forms a sealing abutment is comparatively easy to deform expending only a relatively low actuating force.

The exertion of force necessary for actuating a locking and unlocking mechanism, such as a push-push mechanism, can be reduced in this way. In addition, the radial extension and axial deformability of the first sealing section of the flexible sealing element makes it possible to provide a sufficient functional reliability for the locking and unlocking mechanism even during the long-term operation of the fuel filler door module, even if the flexibility of the sealing element should be subjected to some changes, e.g., as the result of ageing.

As a result of the radial extension and axially facilitated deformability, any ageing processes that may occasionally limit the flexibility of the sealing element have only minor ramifications on the minimal actuating force to be applied to open or close the fuel filler door.

In another embodiment, the first sealing section forms a free end section of the sealing element. In other words, the sealing element exhibits a free end section, roughly in the form of a sealing lip or a sealing profile. The sealing element is typically designed as a sealing profile, wherein the first sealing section represents a free end of the profile cross section. A free end section, i.e., an end section that is only joined with the remaining sealing profile on one side, is especially easy to axially deform.

In another embodiment, the first sealing section of the sealing element extends essentially parallel to the fuel filler door that is in the closed position. In relation to the base geometry of the trough body, the fuel filler door that is in the closed position typically extends in the plane formed by a tangential direction and radial direction. Consequently, the interior side of the fuel filler door extends in a radial plane, so that the first sealing section of the sealing element extending in the radial direction extends parallel and along the interior side of the fuel filler door.

Such a parallel extension, in particular by a free end section of the sealing element, leads to a comparatively large mutual, effective sealing surface or to a comparatively large mutual abutment surface between the first sealing section and fuel filler door. This makes it possible to achieve a good sealing effect, and the interior of the trough body can be effectively protected against the penetration of dust, dirt and/or moisture.

In another embodiment, the sealing element exhibits a second sealing section, which forms a sealing abutment against an opening margin of the body. In this way, the sealing element provided on the fastening edge of the trough body can perform a dual function. On the one hand, its first sealing section can seal the trough body interior away from the fuel filler door. On the other hand, the second sealing section of the sealing element can produce a seal between the trough body and the body.

The first and second sealing section can be joined together into a single piece or be designed as integral constituents to be one and the same flexible sealing element. In particular, the second sealing section can extend radially outward, so as to especially seal an exterior side of the trough body-side fastening edge away from the roughly axially retracted opening margin of the body.

In another embodiment, the fastening edge of the trough body is enveloped by the sealing element. In particular, the sealing element can be annular in design, and continually envelop the fastening edge of the trough body in its entirety. It is here further conceivable that the sealing element envelops the fastening edge of the trough body radially as well. Further, the sealing element can also cross-sectionally overlap and/or border the fastening edge of the trough body like a bulge, so that the trough body, upon reaching a final assembly position, abuts against the motor vehicle body via the fastening edge and against the respective body opening via the sealing element arranged thereon.

In another embodiment, the first sealing section extends in a radial direction, spaced apart from the fastening edge. It can here extend both radially outward and radially inward. Having the first sealing section be spaced axially apart, in particular axially outward in relation to the fastening edge, is especially advantageous for its axial deformability. It is here provided in particular that an interior side of the first sealing section facing away from the fuel filler door have formed on it a free space, which permits a comparatively easy axial deformation and a corresponding axial evasive movement of the first sealing section.

The free space behind or under the first sealing section can be stipulated by the profile geometry of the flexible sealing element. However, it is also conceivable to arrange the first sealing section on the fastening edge in such a way that, while exposed to an inwardly directed pressure exerted by the fuel filler door, it can yield in an axial direction to at least a point where a locking mechanism of the fuel filler door module preferably designed as a push-push mechanism can be switched to its opening configuration.

The first sealing section spaced axially apart from the fastening edge is typically designed in such a way that the sealing section can be inwardly deformed or displaced to such an extent as to enable an excessive pressing of the fuel filler door sufficient for opening the fuel filler door.

In general, a section of the sealing element lying opposite the swiveling axis of the fuel filler door should enable a movement directed toward the middle of the vehicle, i.e., in the axial direction, of up to 10 mm, preferably of 2 to 8 mm, but at least a fuel filler door movement of 3 to 6 mm, or of at least 3 mm.

In another embodiment, the sealing element exhibits a V-shaped, C-shaped or U-shaped cross sectional contour. The first sealing section can here be designed as one of the two legs of a V-, C- or U-shaped cross sectional contour, while the other leg is directly joined with the fastening edge of the trough body, for example. A weakening structure can further be formed in a transitional area between the legs of such a cross sectional contour of the sealing element, thereby facilitating an intended axial deformation and/or a regional bending of the sealing element.

In another embodiment, the first sealing section of the sealing element extends radially inward from the fastening edge of the trough body. It is here provided in particular that the free end section of the sealing element be displaced radially inward in relation to an interior wall section of the trough body. A deformation taking place in an axial direction consequently makes it possible to move or deflect the first sealing section in an axial direction toward the interior wall of the trough body. Given such an inwardly directed radial extension of the first sealing section from the fastening edge, it is further conceivable for the sealing element to exhibit an essentially indentation-free cross sectional contour, e.g., a rectangular, oval, ribbon-type or lath-shaped cross sectional contour.

In a further development of the above, the first sealing section can also project radially inward into the trough body. In this regard, the first sealing section can completely cover the fastening edge of the trough body toward the exterior side of the body. The first sealing section can here form a continuous, radially inwardly projecting sealing lip on the fastening edge of the trough body.

For this embodiment, a further development also provides that the interior side of the fuel filler door exhibit an axially inwardly projecting web, which abuts against the first sealing section of the sealing element in the closed position of the fuel filler door. In particular, the axially inwardly extending web of the fuel filler door can extend essentially perpendicular, i.e., parallel to the surface normal of the essentially planar designed fuel filler door. It is here provided in particular that the fuel filler door-side web protruding in an axial direction extend roughly perpendicular to the radially inwardly extending sealing section of the sealing element.

In this respect, a radially outwardly facing side of the web comes to form a sealing abutment with a radially internal face of the sealing section. It is here provided in particular that the first sealing section extend radially inward to such an extent as to directly engage the axially inwardly projecting web of the fuel filler door. While closing the fuel filler door, the free end of the sealing element projecting radially inward is thus pressed axially inward to at least a slight extent, so that a dirt and moisture-proof arrangement of the fuel filler door and sealing element can be formed.

In another embodiment, the web provided on the fuel filler door is designed as a ring closed in the circumferential direction. The latter exhibits a radially outwardly directed lateral surface, which can be made to form a sealing abutment with the radially inwardly projecting first sealing section of the sealing element. In order to create a complete seal for the internal space of the trough body, it is here provided in particular that the inwardly projecting first sealing section of the sealing element be given an annular and continuously closed design to correspond with the fuel filler door-side web. In this way, an alternating arrangement of fuel filler door and trough body can be provided that forms a complete seal.

In another embodiment, the trough body and sealing element are designed as a two- or multi-component plastic die casting. It can here be provided in particular that the sealing element be joined with the trough body in situ during an injection molding process. This makes it possible to omit a separate process for assembling the sealing element on the trough body. Further, nearly any prescribed geometry for the trough body and/or the sealing element to be arranged thereon can be realized to within a required dimensional accuracy and in a cost-effective manner by appropriately configuring and tailoring the injection molding tools and injection molding processes.

It can further be provided that the sealing element exhibits a plastic material that is comparatively soft and/or elastically deformable by comparison to the trough body. The trough body itself can also be fabricated during a plastic injection molding process. The trough body, in particular its roughly cylindrical pot section, can exhibit a comparatively hard and dimensionally stable plastic, such as polypropylene, while the sealing element exhibits a thermoplastic polymer or thermoplastic elastomer that is soft and deformable by comparison, or consists entirely of such a material.

This makes it possible to provide a structural rigidity sufficient for the trough body on the one hand, and gives the sealing element enough elasticity for its intended purpose on the other. In particular a natural or synthetic rubber is possible for the mentioned thermoplastic polymer, such as ethylene-propylene-diene rubber or a styrene-butadiene rubber.

At least sections of the floor section of the trough body arranged opposite the fastening edge can also be fabricated out of the same plastic material as the sealing element. In particular, an opening margin of the through opening provided for the fuel filler neck can exhibit a bellows-like configuration in the floor section of the trough body, so that the fuel filler neck can be secured to the trough body cushioned against vibration, with comparatively large installation tolerances.

In another aspect a motor vehicle body is provided with a fuel filler door module described above. Finally provided in another aspect is a motor vehicle, in particular a passenger car, which exhibits at least one fuel filler door module described above.

### BRIEF DESCRIPTION OF THE FIGURES

The present disclosure will hereinafter be described in conjunction with the following drawing figures, wherein like numerals denote like elements.

FIG. 1 is a top view of a fuel filler door module as seen from the vehicle interior;

FIG. 2 is a cross section through the fuel filler door module shown in FIG. 1 along intersecting line A-A;

FIG. 3 is a magnified view of the sealing element arranged on the fastening edge of the trough body according to a first embodiment, and

FIG. 4 is a magnified view of another embodiment of the sealing element.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

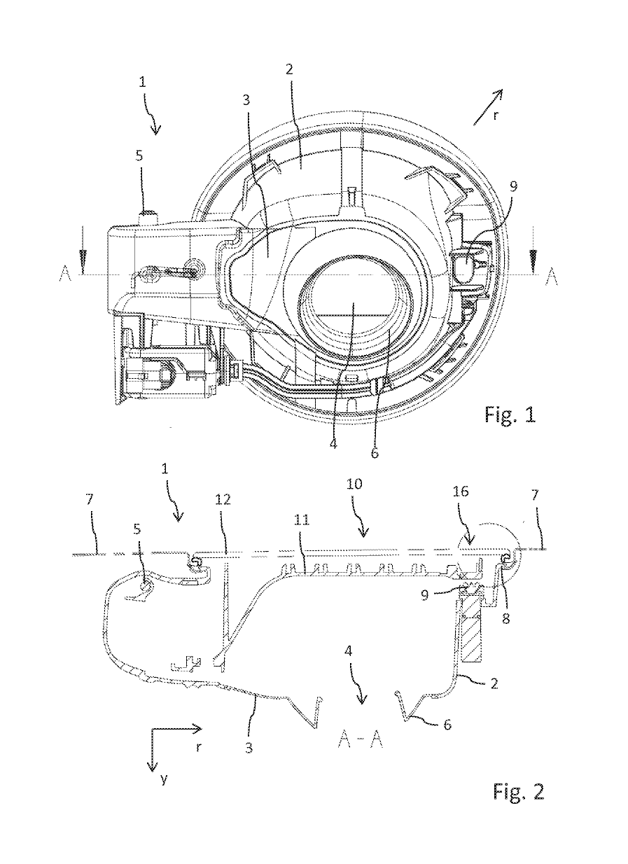

The fuel filler door module 1 depicted from the vehicle interior on FIG. 1 exhibits a trough body 2, which forms a quasi-cylindrical trough for accommodating a fuel filler neck that is not explicitly shown. The trough body 2 exhibits a floor section 3 that is inwardly directed toward the middle of the vehicle, and in which a through opening 4 for accommodating the fuel filler neck is formed.

The opening margin of the through opening 4 is further provided with a bellows-like bezel 6, which typically is made out of a flexible material. As a result, the fuel filler neck can be joined with the trough body 2, and hence with the vehicle body 7, cushioned against vibration, even given comparatively large assembly tolerances.

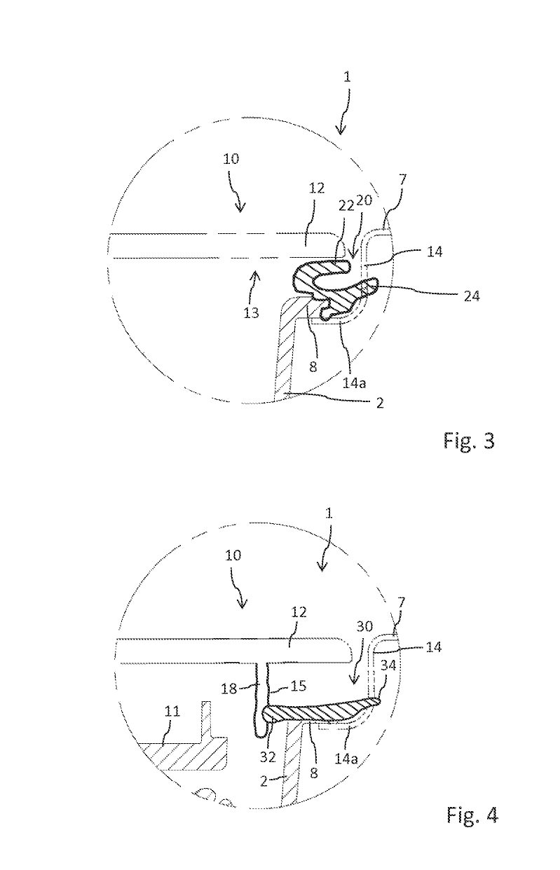

Opposite the floor section 3, the trough body 2 further exhibits a continuous, radially outwardly directed fastening edge 8 with a flange-like design shown on FIG. 2. The trough body 2 can be placed in an opening of a vehicle body 7 provided for the fuel filler door module, and secured to an opening margin 14 provided there and denoted on FIGS. 3 and 4.

As depicted on FIGS. 3 and 4, the opening margin 14 exhibits a radially inwardly directed fastening flange 14a that is retracted by comparison to the exterior side of the body 7, and against which the radially outwardly protruding fastening edge 8 of the trough body 2 is supported axially, i.e., in the transverse direction of the vehicle (y), in the final installation position.

The fuel filler door module 1 further exhibits a fuel filler door 10 pivoted to the trough body 2. The fuel filler door 10 is pivoted to a swiveling axis 5 of the trough body 2. A locking and unlocking mechanism 16 is provided on a side of the trough body 2 lying opposite the swiveling axis 5, which typically can be activated like a push-push mechanism. In this regard, the trough body 2 is provided with an end stop 9, against which the fuel filler door 10 can be pressed to bring about an unlocked configuration. The fuel filler door 10 in this respect exhibits a door support 11, which interacts with the end stop 9 of the trough body 2 to exert a locking or unlocking action. A cover plate 12 is axially spaced apart from the door support 11 and secured thereto, which in the closed position shown on FIG. 2 comes to lie essentially flush with the outer contour of the adjoining body 7.

As depicted in the two magnified views on FIGS. 3 and 4, a sealing element 20, 30 is arranged on the radially outwardly projecting fastening edge 8 designed roughly as a flange. The sealing element 20 exemplarily depicted in cross section on FIG. 3 exhibits a free first sealing section 22 that extends essentially in the radial direction (r), and forms a sealing abutment on the interior side 13 of the fuel filler door 10, on roughly the interior side of the cover plate 12 of the fuel filler door 10.

The first sealing section 22 is here designed as a free end section of the sealing element 20, so that a hollow space or free space remains in the axial direction between the first sealing section 22 and the remaining sealing element 20. The latter allows an especially easy and reversible elastic deformation of the first sealing section 22 in the axial direction (y), for example when excessively pressing the fuel filler door 10 axially inward.

The sealing element 20 is C-shaped or U-shaped in design, and extends over the entire outer circumference of the fastening edge 8. Because the first sealing section 22 of the sealing element 20 extends approximately parallel to the interior side 13 of the fuel filler door 10, and hence parallel to the cover plate 12, a comparatively large-area, mutual abutment surface also arises between the first sealing section 22 and the fuel filler door 10. An especially good sealing effect can be provided in this way.

In addition, the sealing element 20 exhibits a second, radially outwardly extending sealing section 24, which comes to form a sealing abutment against the body-side opening margin 14. In this way, the sealing element 20 can provide a twofold sealing function. It can provide a seal between the trough body 2 and fuel filler door 10 with its first sealing section 22, and a seal between the trough body 2 and adjacent vehicle body 7 with its second sealing section 24.

Due to its cross section, namely a C-, V- or U-shaped cross sectional geometry, and the resultant leg that comes to abut against the interior side 13 of the fuel filler door 10, the sealing element 20 is especially easy to deform in the axial direction (y). In this regard, an actuating force for the locking and unlocking mechanism can be reduced.

In the alternative embodiment according to FIG. 4, the sealing element 30 exhibits an essentially straight or planar surface contour. The sealing element 30 is provided with a first sealing section 32 that extends in the radial direction here as well. However, while the first sealing section 22 of the sealing element 20 according to FIG. 3 extends radially outward, the first sealing section 32 of the sealing element 30 shown on FIG. 4 is directed radially inward.

As depicted on FIG. 4, the first sealing section 32 also designed as a free end section of the sealing element 30 protrudes into the trough body 2, and thus comes to rest spaced apart from the interior side of the trough body 2. In addition to the above, the fuel filler door 10, here its cover plate 12, exhibits an axially inwardly directed, annular web 18, whose radially outwardly directed lateral surface 15 interacts with the free end of the radially inwardly directed first sealing section 32 of the sealing element 30 in a sealing or frictional manner.

The first sealing section 32 of the sealing element 30 shown in FIG. 4 in cross section along with the axially inwardly projecting web 18 are annularly or continually arranged along the fastening edge 8 or along the outer contour of the fuel filler door 10, so as to be able to provide a continuous and complete seal. The alternative embodiment depicted on FIG. 4 can also be used to provide for a particularly effortless actuation of the locking and unlocking mechanism based on the push-push principle.

The first sealing section 32 of the sealing element 30 extending radially inwardly like a lip is relatively easy to deform in the axial direction (y) due to its comparatively thin configuration, but even more so also because it is arranged so as to extend freely inward into the interior of the trough body 2. As in the case of the sealing element 20, the sealing element 30 also exhibits a radially outwardly protruding, second sealing section 34, with which the trough body 2 can be arranged so as to achieve a seal with the opening margin 14 of the motor vehicle body 7.

Let it further be noted with respect to the depictions on FIGS. 3 and 4 that the sealing elements 20, 30 possibly mounted on the fastening edge 8 under a pre-stress are each shown in their completely relaxed basic configuration, in which they seemingly pass through the opening margin 14 of the body. In this regard, the cross sectional views on FIGS. 3 and 4 reflect the degree of required deformation for the sealing elements 20, 30 during use as intended.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-14. (canceled)

15. A fuel filler door module for installation in a motor vehicle comprising:
a trough body configured to be placed in a vehicle body and having an axial through opening for accommodating a fuel filler neck and a radially outwardly projecting fastening edge for attachment to the motor vehicle body;
a fuel filler door pivoted to the trough body; and
a flexible sealing element arranged on the fastening edge, the flexible sealing element includes a first sealing section that forms a sealing abutment against an interior side of the fuel filler door, extends in the radial direction and is deformable in an axial direction.

16. The fuel filler door module according to claim 15, wherein the first sealing section forms a free end section of the sealing element.

17. The fuel filler door module according to claim 15, wherein the first sealing section extends essentially parallel to the fuel filler door when in the closed position.

18. The fuel filler door module according to claim 15, wherein the sealing element comprises a second sealing section configured to form a sealing abutment against an opening margin of the vehicle body.

19. The fuel filler door module according to claim 15, wherein the fastening edge of the trough body is enveloped by the sealing element.

20. The fuel filler door module according to claim 15, wherein the first sealing section extends in a radial direction, spaced apart from the fastening edge.

21. The fuel filler door module according to claim 20, wherein the sealing element has a cross-sectional contour having at least one of a V-shaped, C-shaped or U-shaped configuration.

22. The fuel filler door module according to claim 15, wherein the first sealing section extends radially inward from the fastening edge.

23. The fuel filler door module according to claim 22, wherein the first sealing section projects radially inward into the trough body.

24. The fuel filler door module according to claim 22, wherein the interior side of the fuel filler door comprises an axially inwardly projecting web, which abuts against the first sealing section of the sealing element in the closed position of the fuel filler door.

25. The fuel filler door module according to claim 24, wherein the web comprises a ring closed in the circumferential direction and a radially outwardly directed lateral surface configured to form a sealing abutment with the radially inwardly projecting first sealing section.

26. The fuel filler door module according to 15, wherein the trough body and the sealing element comprise a plastic die casting having at least two components.

27. A motor vehicle body comprising a fuel filler door module according to claim 15.

28. A motor vehicle comprising a vehicle body having a fuel filler door module according to claim 15.

29. A motor vehicle body comprising:
a body panel;
a trough body placed in the body panel and having an axial through opening for accommodating a fuel filler neck and a radially outwardly projecting fastening edge attached to the body panel;
a fuel filler door pivoted to the trough body; and
a flexible sealing element arranged on the fastening edge, the flexible sealing element including a first sealing section that forms a sealing abutment against an interior side of the fuel filler door, extends in the radial direction and is deformable in an axial direction.

30. A motor vehicle comprising:
a vehicle body having a body panel;
a fuel filler neck;
a trough body placed in the body panel and having an axial through opening to accommodate the fuel filler neck and a radially outwardly projecting fastening edge attached to the body panel;
a fuel filler door pivoted to the trough body; and
a flexible sealing element arranged on the fastening edge, the flexible sealing element including a first sealing section that forms a sealing abutment against an interior side of the fuel filler door, extends in the radial direction and is deformable in an axial direction.
